(19) United States
(12) Patent Application Publication
(10) Pub. No.: US 2003/0008195 A1
(43) Pub. Date: Jan. 9, 2003

(54) Fluid diffusion layers for fuel cells

(76) Inventors: Bien Hung Chiem, Burnaby (CA); Herwig Robert Haas, Vancouver (CA); Jurgen Stumper, Vancouver (CA); Kelvin Keen-Ven Fong, Burnaby (CA); Sonia Geillis Wong-Cheung, Burnaby (CA); Hong Cao, Burnaby (CA); Paul Kozak, Surrey (CA); Michael Todd Davis, Port Coquitlam (CA)

Correspondence Address: Robert W. Fieseler, McAndrews, Held & Malloy, Ltd., 500 West Madison Street, 34th Floor, Chicago, IL, 60661, US

(21) Appl. No.: 10/177,961

(22) Filed: Jun. 21, 2002

Related U.S. Application Data
(60) Provisional application No. 60/301,735, filed on Jun. 28, 2001.

(51) Int. Cl. H01M 4/88; H01M 4/96; B01J 21/18; B05D 5/12

(52) U.S. Cl. 429/40; 429/44; 502/101; 427/115; 502/180

(57) ABSTRACT

Fluid diffusion layers, as well as methods and compositions for making such fluid diffusion layers, include a loading material comprising both carbon black and graphite particles in a weight ratio of less than about 50:50. The fluid diffusion layers have favorable mechanical and electrical properties, such as air flow and through-plane resistance.

### CROSS-REFERENCE TO RELATED APPLICATION(S)

This application is related to and claims priority benefits from U.S. Provisional Patent Application Serial No. 60/301,735, filed Jun. 28, 2001, entitled “Fluid Diffusion Layers for Fuel Cells”. The '735 provisional application is hereby incorporated by reference herein in its entirety.

### FIELD OF THE INVENTION

The present invention relates to fluid diffusion layers and to methods and compositions for preparing fluid diffusion layers, in particular for solid polymer electrolyte fuel cells. The present invention relates to loading compositions comprising carbon black and graphite particles and adapted to be applied to a substrate as part of a method of preparing a fluid diffusion layer.

### BACKGROUND OF THE INVENTION

Electrochemical fuel cells convert fuel and oxidant to electricity and reaction product. Solid polymer electrolyte fuel cells generally employ a membrane electrode assembly (“MEA”) comprising a solid polymer electrolyte or ion exchange membrane disposed between two electrically conductive electrodes. The electrodes typically comprise a fluid diffusion layer and a catalyst layer. The fluid diffusion layer comprises a substrate with a porous structure having voids therein. The substrate (typically a porous, electrically conductive sheet material) is employed for purposes of mechanical support and/or reactant distribution. The substrate is permeable to fluid reactants and products in the fuel cell.

During normal operation of a solid polymer electrolyte fuel cell, fuel is electrochemically oxidized at the anode catalyst, resulting in the generation of protons, electrons, and possibly other species depending on the fuel employed. The protons are conducted from the reaction sites at which they are generated, through the electrolyte, to electrochemically react with the oxidant at the cathode catalyst. The catalysts are typically disposed in a layer at each membrane/electrode interface, to induce the desired electrochemical reaction in the fuel cell. However, the catalyst can be disposed as a layer on the electrode or the ion exchange membrane, or it can be part of the electrode in some other way. The electrodes are electrically coupled to provide a path for conducting electrons between the electrodes through an external load.

The catalysts (also referred to as electrocatalysts) typically induce the desired electrochemical reactions at the electrodes. The catalyst can, for example, be a metal black, an alloy, or a supported metal catalyst such as platinum on carbon. The catalyst layer can contain ionomer similar to that used for the solid polymer electrolyte (for example, NAFIONO perfluorosulfonate ionomer). The catalyst layer can also contain a binder, such as polytetrafluoroethylene.

The MEA is typically disposed between two flow field plates to form a fuel cell assembly. The flow field plates are used to distribute reactants over the surfaces of the fluid diffusion layers and also act as current collectors and provide support for the adjacent electrodes. The fuel cell assembly is typically compressed to ensure good electrical contact between the plates and the electrodes, in addition to good sealing between fuel cell components. A plurality of fuel cell assemblies can be combined in series or in parallel to form a fuel cell stack. In a fuel cell stack, a plate may be shared between two adjacent fuel cell assemblies, in which case the plate also serves as a separator to fluidly isolate the fluid streams of the two adjacent fuel cell assemblies.

A broad range of fluid reactants can be employed in solid polymer electrolyte fuel cells and can be supplied in either gaseous or liquid form. For example, the oxidant stream may be substantially pure oxygen gas or a dilute oxygen stream such as air. The fuel may be, for example, substantially pure hydrogen gas, a gaseous hydrogen-containing reformate stream, or an aqueous liquid methanol solution or mixture in a direct methanol fuel cell. Reactants are directed to the fuel cell fluid diffusion layer and are distributed to the catalyst. In the case of gaseous reactants, these layers have been referred to as gas diffusion layers.

There are many design considerations for a fluid diffusion layer. Some of these include fuel cell functionality, mechanical strength, electrical conductivity, thermal transfer properties, smoothness, desired water management properties, and gas porosity. Additionally, reliability, production cost, and suitability for large scale manufacture are considerations. The fluid diffusion layers are preferably thin, lightweight, inexpensive, and readily prepared using mass production techniques (for example, reel-to-reel processing techniques).

As mentioned above, the fluid diffusion layer comprises a substrate. Materials commonly used as substrates or as starting materials to form substrates include carbon fiber paper, woven and nonwoven carbon fabrics, metal mesh or gauze, and other woven and nonwoven materials. Such materials are commercially available in flat sheets and, when the material is sufficiently flexible, in rolls. Substrate materials tend to be highly electrically conductive, and macroporous fluid diffusion layers may also contain a particulate electrically conductive material and a binder.

However, the mechanical and/or electrical properties of these substrate materials alone may not be adequate to meet all the requirements for fuel cell applications.

It has sometimes been found advantageous to coat porous electrically conductive substrates with materials, such as carbon or graphite materials, in order to reduce porosity or achieve some other object. The material applied to the substrate is referred to herein as “loading material.” When loading material is applied to one side of a substrate to form a layer, the formed layer is frequently referred to as a “sublayer.” The amount of loading material (that is, the material eventually loaded onto the substrate) in a fluid diffusion layer or an electrode is referred to as the average amount or “loading” of loading material and is usually expressed as the mass of material per unit surface area of substrate.

A certain loading of carbon or graphite can improve the operational performance of an electrode. However, if the loading is too high, performance is impaired by interference with diffusion of product or reactant through the fluid diffusion layer. Nonetheless, substrates having larger pores or a higher porosity (for example, the thin, highly porous, non-woven carbon fiber products of Technical Fibre Products Ltd. tend to have higher loadings of carbon or graphite. Substrate having smaller pores or lower porosity tend to have lower loadings.

A substrate need not be highly electrically conductive and in fact can be an electrical insulator. Such substrates may be filled with electrically conductive materials. Electrodes which are made from filled, poorly electrically conductive webs and methods for making same are disclosed in U.S. Pat. Nos. 5,863,673 and 6,060,190, which are incorporated herein by reference.

A substrate for an electrode typically has a loading material applied to it in order to provide a surface for electrocatalyst, to improve conductivity, and/or to accomplish some other objective. The loading material can be applied by any of the numerous coating, impregnating, filling or other techniques known in the art. The loading material can be contained in an ink or paste that is applied to the substrate.

Appropriate “sublayers” or loading materials have been employed in the art to improve one or more of these properties. These sublayers or loading materials are adhered to the substrate and form part of the fluid diffusion layer. For instance, the electrical conductivity of a carbonaceous web might be increased by filling it to a certain extent with an electrically conductive material, such as acetylene carbon black or graphite particles. (Carbonaceous in this context simply means containing carbon.) The loading material typically includes a binder as well, such as polytetrafluoroethylene or another polymer.

There is a need for fluid diffusion layers and electrodes having improved mechanical and electrical properties. There is also a need for improved methods of preparing fluid diffusion layers and electrodes.

### SUMMARY OF THE INVENTION

A method of making a fluid diffusion layer for improved performance in a fuel cell includes providing a substrate, applying a loading composition to the substrate, and drying the substrate and loading composition applied thereto. The loading composition comprises loading material, a carrier, and optionally a binder, a poreformer, and/or a surfactant. The loading material comprises both carbon black and graphite particles in a weight ratio less than about 50:50, alternatively about 10:90.

As another aspect, an improved fluid diffusion layer is provided. The fluid diffusion layer comprises a substrate and a loading material, and the loading material comprising carbon black and graphite particles. The loading material comprises carbon black and graphite particles in a weight ratio less than about 50:50. Alternatively, the fluid diffusion layer comprises carbon black and graphite in a ratio such that the fluid diffusion layer has a through-plane resistivity of about 0.5 milliohm-cm² or less and an air flow at 1 psi (6.9 kPa) of 80,000 cc/min or more.

As yet another aspect, an improved loading composition is provided. The loading composition is adapted to be applied to a substrate for the preparation of a fluid diffusion layer of the type used in solid polymer electrolyte fuel cells. The loading composition comprises a loading material and a carrier, wherein the loading material comprises both carbon black and graphite particles in a weight ratio of less-than about 50:50, preferably about 10:90. The loading composition can further comprise a binder such as polytetrafluoroethylene and/or poly(vinylidene fluoride) and/or a poreformer such as methylcellulose.

As a further aspect, a method of preparing a fuel cell electrode is provided. The method comprises providing a substrate, applying a loading composition to the substrate, drying the substrate and the loading composition applied thereto. A fluid diffusion layer is formed as a result of the applying and drying steps. The method also can comprise applying an aqueous catalyst composition comprising a fuel cell catalyst to the fluid diffusion layer, and drying the fluid diffusion layer and the aqueous catalyst composition applied thereto, whereby an electrode is formed. The loading composition comprises a loading material and a carrier, and the loading material comprises both carbon black and graphite particles in a weight ratio of less than about 50:50, preferably about 10:90.

As yet another aspect, a fuel cell electrode is provided. The fuel cell electrode comprises a fluid diffusion layer and a catalyst layer. The fluid diffusion layer comprises a substrate and a loading material. The loading material comprises both carbon black and graphite particles in a weight ratio of less than about 50:50, preferably-about 10:90.

### BRIEF DESCRIPTION OF THE DRAWINGS

FIG. 1 is an illustration of an electrode for a solid polymer electrolyte fuel cell comprising a fluid diffusion layer and a catalyst layer.

FIG. 2 is a graph of polarization curves for three membrane electrode assemblies, one of which comprises a present fluid diffusion layer.

FIG. 3 is a graph of polarization curves for the same three membrane electrode assemblies under different conditions.

FIG. 4 is a bar-graph showing the through-plane resistance for fluid diffusion layers made with loading materials comprising varying weight ratios of acetylene carbon black to graphite particles.

FIG. 5 is a graph showing the air flow at 1 psi (6.9 kPa) through fluid diffusion layers made with loading materials comprising varying weight ratios of acetylene carbon black to graphite particles.

### DETAILED DESCRIPTION OF PREFERRED EMBODIMENT(S)

The present methods are particularly well suited for a large-scale manufacturing process for making fluid diffusion layers and electrodes for a solid polymer electrolyte fuel cell because the substrate can be provided in a continuous roll. The substrate material is preferably a non-woven carbon fiber material having a density in a range of between about 17 g/m² and about 34 g/m². The fluid diffusion layer can be prepared from a commercially available material originally containing combustible materials, but preferably the combustible materials are removed by sintering or other heat treatment.

The loading composition comprises both carbon black and graphite particles in a preferred weight ratio for fuel cell performance and is preferably applied in the form of an ink. A preferred carbon black is acetylene carbon black. The ink is applied to one side of the substrate in the machine direction, as the substrate is unrolled. The same loading composition can be applied to the other side of the substrate, if desired. However, it is presently preferred to apply the loading composition merely to one side of the substrate, namely, the side to which a catalyst will be applied and which will form an interface with the ion exchange membrane.

The loading composition can also comprise a poreformer such as methylcellulose, preferably in an amount of from about 15 percent to about 20 percent by weight of the solids in the loading composition. The loading composition can include a loading material binder such as PTFE, preferably, in an amount of from about 18 to about 25 percent by weight of the solids in the loading composition. The loading material binder can further comprise, in addition to or as an alternate to the PTFE, another binding agent to add strength. Additionally, the present methods for making a fluid diffusion layer can include a compacting step. The compacting step can be accomplished with a backing layer and is performed at a pressure of about 0.3 MPa or more. Compacting can be performed for any suitable time, such as, for example, approximately 20 seconds. The compacting step can be performed at a pressure of about 0.75 MPa or less.

Further, the present methods may include a drying step, preferably performed by an infrared lamp set at a suitable temperature, for example, between about 60° C. and about 80° C. By drying in this fashion, the fluid diffusion layer and loading composition applied thereto may be sufficiently dried after several minutes. The compacting and drying steps can be performed more than once.

The present method can also comprise a sintering step to sinter incorporated binder (for example, PTFE). The sintering step also preferably removes substantially all combustible materials from the substrate. The sintering step preferably occurs at a temperature between about 300° C. and about 400° C., for between about 3 and about 30 minutes in an oxidizing environment. The sintering step can also be accomplished at a pressure greater than atmospheric.

After the loading material is adhered to the substrate, thereby forming a continuous sheet of fluid diffusion layer, the sheet can then be flush-cut orthogonal to the roll to form fluid diffusion layers of the desired length.

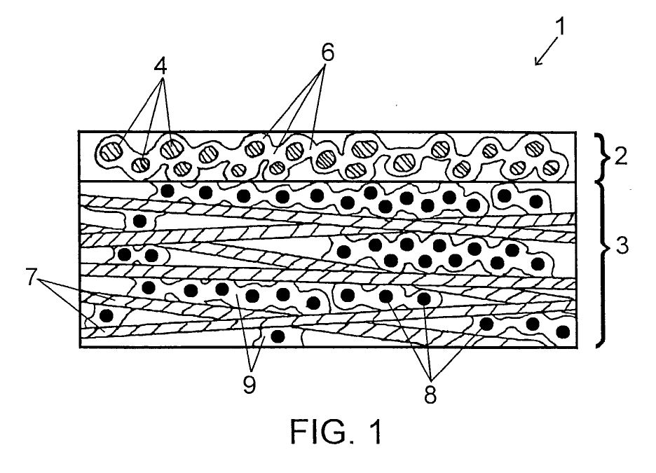

FIG. 1 illustrates an electrode 1 for a solid polymer electrolyte fuel cell that is prepared using an embodiment of the present methods. FIG. 1 is not intended as a life-like rendition, and certain aspects are understood by those skilled in the art without being shown. Electrode 1 comprises catalyst layer 2 and fluid diffusion layer 3. Catalyst layer 2 comprises catalyst particles 4 and catalyst binder 6. Fluid diffusion layer 3 comprises non-woven carbon fiber substrate 7 and loading material 8. It is understood, of course, that catalyst particles 4 and loading material 8 (comprising both carbon black and graphite) are not completely surrounded by binder but rather are accessible chemically and/or electrically as required. The fluid diffusion layer 3 may optionally include binder 9. The fluid diffusion layer 3 is porous so that fluid reactant can readily pass through the fluid diffusion layer and access the catalyst layer and so that by-products can be readily removed. While shown without an overlap between the catalyst layer and fluid diffusion layer, some amount of overlap is typical.

Such fluid diffusion layers can be prepared by the following method. First, a substrate is obtained, either by purchasing a commercially available material or by preparing a material. In a preferred embodiment, the substrate is a non-woven carbon fiber web having a density of approximately 17-34 g/m². An example of such a material is 20352A0017, available from Technical Fibre Products, Ltd. A wet-proofing agent can be applied to the substrate, before adding loading composition to the substrate. PTFE solution is an appropriate material for wet-proofing the substrate prior to adding loading material. Wet-proofing can result in better adhesion of loading material and mechanical strength.

Then, a loading composition comprising carbon black and graphite in a preferred ratio for purposes of fuel cell performance is prepared. The loading composition can be an ink, a paste, or another form. The loading composition comprises carbon black, graphite, a carrier, and optionally a binder, a poreformer, a surfactant, and/or a wet-proofing agent (although the binder may function as a wet-proofing agent). For example, PTFE can function as both a binder and wet-proofing agent. The binder typically makes up about 18 to 25 percent by weight of the loading composition. Water is a suitable carrier.

Super P from Erachem Europe SA and Shawinigan acetylene carbon black from Chevron Phillips Chemical Company LP are examples of acetylene carbon black. Graphite particles, such as M450 from Asbury or KS75 from Timcal America Inc., can be employed as the graphite particles of the loading material. Alternatively, larger graphite particles, such as KS175 from Timcal, can be employed. Larger graphite particles can be employed to attain a desirable thickness of the fluid diffusion layer (for example, 175 μm).

In addition to the loading material, the loading composition preferably also includes a loading material binder. One embodiment uses PTFE as both a wet-proofing agent and binder in the loading composition. An example of a suitable PTFE is P 30 B, available from E.I. Du Pont de Nemours and Company (TEFLON® PTFE grade 30B).

The loading composition can also include a poreformer to provide the desired porosity for the fluid diffusion layer. A preferred poreformer is methylcellulose. A commercially available source is Dow FM grade methylcellulose. A preferred embodiment of the loading composition contains methylcellulose as from about 15% to about 20% by weight of the solids of the loading composition.

In a preferred loading composition, the solids portion contains about 5-7% by weight acetylene carbon black, 50-60% by weight graphite particles, 15-20% by weight methylcellulose, 18-25% by weight polytetrafluoroethylene, and the loading composition is an aqueous mixture with a solids content of about 20% by weight or less.

A surfactant can be included in the loading composition or be separately applied to the substrate, to facilitate the application and penetration of loading material to the substrate.

As one embodiment, the loading composition consists essentially of acetylene carbon black, graphite particles, a binder (such as polytetrafluoroethylene, poly(vinylidene fluoride), and mixtures thereof), a poreformer (such as methylcellulose), and a carrier.

Then, the loading composition is applied to the substrate. The loading composition can be coated onto the substrate as the substrate is unrolled from a machine. Preferably, a loading composition ink is coated on one side of the substrate in the machine direction. Conventional coating apparatus can be employed, such as a knife coater. The substrate can be flush cut orthogonal to the roll to proper length after cutting to provide individual fluid diffusion layers. The average amount of loading composition applied to the substrate preferably is in the range of from about 80 g/m² to about 160 g/m² but may be higher or lower. It is also contemplated that the applying process could be carried out in stages. After adding the loading composition, the coated substrate can be compacted against a backing layer. Mylar® brand polyester (polyethylene terephthalate) film is a preferred material for the backing layer, because it is re-usable, inexpensive, and smooth, and it has desirable surface properties. The compaction can be performed under a pressure of about 0.3 MPa or more for approximately 20 seconds.

The coated/compacted substrate is then dried under an infrared lamp set at about 60° C. to about 80° C. for about 3 minutes. Drying could be achieved by other methods, such as using rollers to squeeze out water.

Finally, the coated/compacted substrate is sintered to sinter the binder and to remove combustible materials present (such as the styrene-acrylic binder in one embodiment) leaving the PTFE to act as both the supporting binder holding the fluid diffusion layer components together and as the wet-proofing agent. Thus, an additional function of the sintering step is to remove materials that can induce combustion during fuel cell operation.

Such combustible materials include poreformers such as methylcellulose (which combusts around 300° C.), surfactants such as Triton X-100® octylphenoxypolyethoxyethanol nonionic surfactant (which combusts at 240° C.), and the above mentioned styrene-acrylic binder (which combusts around 350° C.). The removal of methylcellulose ensures that the fluid diffusion layer will have porosity. The styrene-acrylic binder is present in a substrate available in roll form. The Triton X-100® surfactant is often present in solutions containing PTFE. If these materials were to combust in an operating fuel cell, they could cause damage and make the fuel cell unreliable.

Preferably, the sintering step is performed in an approximate temperature range of about 300° C. to about 400° C. for about 3 to about 30 minutes. More preferably, the sintering will take place at about 350° C. or higher. Using higher temperatures tends to involve less sintering time.

After preparing suitable fluid diffusion layers, electrodes and fuel cells comprising these fluid diffusion layers can be prepared in a conventional manner.

When referring to the substrate and the loading material or loading composition “applied thereto”, it is contemplated that certain amounts of loading material or loading composition which were applied in the applying step can be lost before compacting, drying or sintering as part of the normal losses associated with a manufacturing process. For example, when it is stated that the substrate and the loading composition applied thereto are dried, it means that the substrate and applied loading composition remaining on the substrate, and not including loading composition or components thereof lost or removed as part of the process of preparing the fluid diffusion layer, are dried.

Those skilled in the art will appreciate that various properties of the substrate and loading material (including pore structure, wettability, and other mechanical or electrical properties) can be controlled to a certain extent by varying the type of substrate and/or by varying the amounts of loading material.

### EXAMPLE

Preparation Of Fluid Diffusion Layers

Comparative fluid diffusion layers with loading comprising acetylene carbon black and no graphite were prepared according to the following method. As a substrate, a carbon fiber mat was obtained from Technical Fiber Products (product no. 20352A). The substrate had a 17 g/m² basis weight and comprised a carbon fiber non-woven material. A loading composition was prepared as an emulsified mixture. The solids content of this loading composition was about 8% by weight, with the balance being water. The solids in the loading composition comprised 67% by weight Shawinigan carbon (acetylene black; from Chevron), 15% by weight methylcellulose (from Sigma Aldrich), and 18% by weight PTFE (P 30 B from DuPont). (The surface area of the Shawinigan carbon was 80 m²/g and the particle size 42 nm.) The loading composition was applied to the substrate using an RK-print coat K-couture (knife coater) set at a blade gap of 0.020 inches. After the substrate was coated with the loading composition, the coated substrate was covered with a sheet of Vitafilm® polyvinyl-chloride (PVC) release material (from Huntsman Film Products of Canada Limited.) and compacted at a pressutreof 3.4 bar for 20 seconds. After compaction, the Vita film release material was removed from the coated substrate, and the substrate and loading composition applied thereto were air dried for approximately 16 hours (overnight). Then, the same applying, compaction, and drying steps were repeated on the opposite side of the substrate. The dried substrate and loading material applied thereto were then sintered at 400° C. for 10 minutes. The finished fluid diffusion layers had an average amount of loading material of 5.6 mg/cm².

Inventive fluid diffusion layers comprising both acetylene carbon black and graphite particles as the loading material were prepared according to the following method. The same substrate material (carbon fiber mat obtained from Technical Fiber Products (Product No. 20352A)) was coated with a different loading composition containing a mixture of acetylene carbon black and graphite particles in a weight ratio of about 10:90. The loading composition was an emulsified mixture. The solids content of the loading composition was about 18-20% by weight, and the solids in this loading composition were 60.3% by weight M450 graphite (from Asbury), 6.7% by weight of Super P carbon (from Erachem), 18% by weight PTFE (P 30 B from DuPont) and 15% by weight methylcellulose (from Sigma Aldrich). (The surface area of the Super P carbon was 60 m²/g and the particle size 40 nm.) The same applying, compaction, and drying steps were performed on each side of the substrate. The finished fluid diffusion layers had an average amount of loading material of 13 mg/cm², thereby maintaining comparable thickness with the foregoing comparative fluid diffusion layers.

Comparative fluid diffusion layers with loading comprising graphite and no acetylene carbon black were prepared according to the following method. The same substrate material (carbon fiber mat obtained from Technical Fiber Products (Product No. 20352A)) was coated with a different loading composition containing graphite. The loading composition was an emulsified mixture. The solids content for this loading composition was about 18-20% by weight. The solids in this loading composition were 67% by weight M450 graphite (from Asbury), 15% by weight methylcellulose (from Sigma Aldrich), and 18% by weight PTFE (P 30 B from DuPont). After sintering, the finished fluid diffusion layers had an average amount of loading material of 10.5 mg/cm², thereby maintaining comparable thickness with the foregoing fluid diffusion layers.

Preparation Of Fuel Cell Electrodes

An anode and a cathode for a fuel cell were made using a fluid diffusion layer of each of the foregoing types. An appropriate catalyst layer was applied to a fluid diffusion layer in order to form an electrode. To form an anode, a catalyst layer was screen printed on the fluid diffusion layer using a NAFION® based catalyst ink. The solids in the anode catalyst ink comprised 23% by weight aqueous NAFION® (1100EW from DuPont) and 77% by weight Pt/Ru (20/10) Vulcan/XC72R. The anode had an average amount of catalyst of 0.3 mg/cm². To form a cathode, a catalyst layer was screen printed on a fluid diffusion layer. The catalyst composition comprised a NAFION® based catalyst ink. The solids in the cathode catalyst ink comprised 23% by weight aqueous NAFION® (1100EW from DuPont) and 77% by weight Pt (40% Pt on Vulcan/XC72R). In other words, each of the catalysts were supported on Vulcan carbon. Both the anodes and cathodes were spray coated with 5% NAFION® (alcohol based, 1100EW from DuPont) solutions at 80°C. The average amount of dried solid NAFION® coating on the electrodes was 0.2 mg/cm². Preparation Of Membrane Electrode Assemblies

The foregoing electrodes were used to prepare membrane electrode assemblies. Each membrane electrode assembly comprised two fluid diffusion layers of the same type. That is, one membrane electrode assembly comprised fluid diffusion layers comprising only acetylene carbon black and no graphite; one comprised fluid diffusion layers comprising only graphite and no acetylene black; and one comprised fluid diffusion layers comprising acetylene carbon black and graphite in a weight ratio of about 10:90. The membrane electrode assemblies were prepared by compressing a cathode, an ion exchange membrane and an anode together at a pressure of 20 bar and a temperature of 170° C. for 2 minutes. The ion exchange membrane used for these membrane electrode assemblies was NAFION® 112 membrane.

Testing Of Membrane Electrode Assemblies

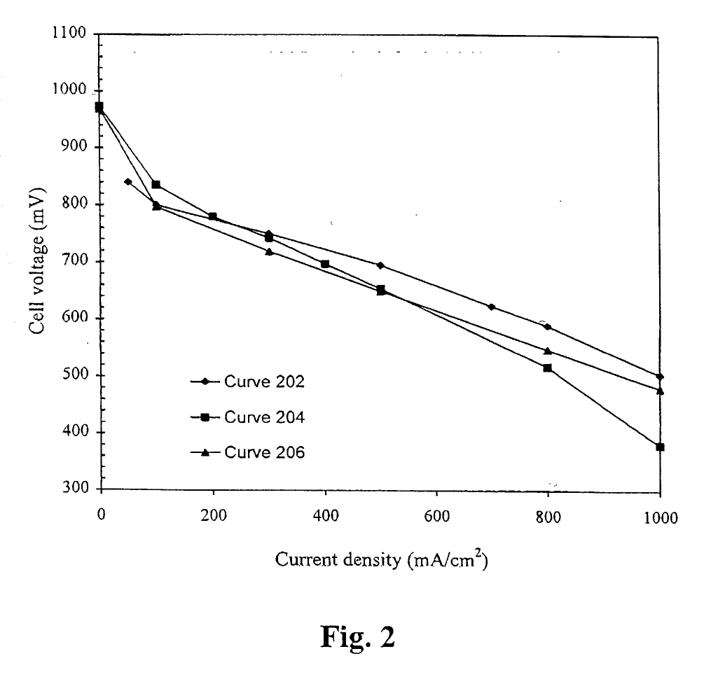

The foregoing membrane electrode assemblies were tested under a variety of operating parameters to assess their performance. FIG. 2 shows the polarization curves for the three types of membrane electrode assemblies. Curve 202 shows the voltage versus current density performance of the membrane electrode assembly having fluid diffusions layers with the 10:90 mixture of acetylene carbon black and graphite particles in the loading material. Curve 204 shows the performance of the membrane electrode assembly comprising fluid diffusion layers with a loading material comprising graphite without acetylene carbon black. Curve 206 shows the performance of the membrane electrode assembly comprising fluid diffusion layers with acetylene carbon black without graphite in the loading material. As shown in FIG. 2, the membrane electrode assembly comprising the fluid diffusion layers with a mixture of acetylene carbon black and graphite particles had better performance at higher current densities than the other two membrane electrode assemblies.

For this testing, the membrane electrode assemblies were fed with air as the oxidant and hydrogen gas as the fuel. Each of the reactant streams was supplied at a pressure of 23 psig (158.6 kPa). The stoichiometric ratio for air was 1.5 and for hydrogen was 1.2. The temperature of the reactants flowing into the fuel cell was 70° C., and the change in temperature as they passed through the fuel cell was about 10° C. at a current density of 1000 mA/cm². The dew points for the fluid streams was 70° C.

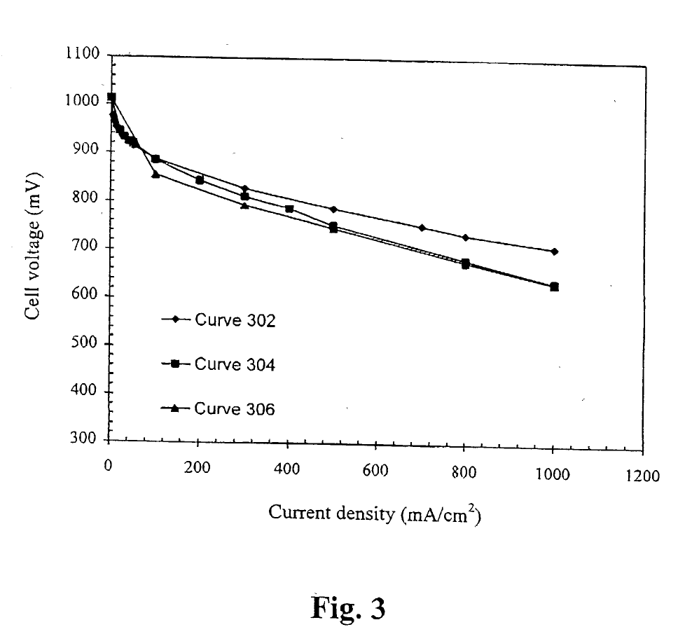

FIG. 3 shows a polarization curve for the same membrane electrode assemblies operated with oxygen as the oxidant. Curve 302 shows the voltage versus current density performance of the membrane electrode assembly having fluid diffusions layers with a 10:90 mixture of acetylene carbon black and graphite particles in the loading material. Curve 304 shows the performance of the membrane electrode assembly comprising fluid diffusion layers with a loading material comprising graphite without acetylene carbon black. Curve 306 shows the performance of the membrane electrode assembly comprising fluid diffusion layers with a loading material of acetylene carbon black without graphite. For this testing, the membrane electrode assemblies were fed with hydrogen gas as the fuel and pure oxygen as the oxidant. Each of the reactant streams were supplied at a pressure of 23 psig (158.6 kPa). The stoichiometric ratio for air was 1.5 and for hydrogen was 1.2. The temperature of the reactants flowing into the fuel cell was 70° C., and the change in temperature as they passed through the fuel cell was about 10° C. at a current density of 1000 mA/cm². The dew points for the fluid streams was 70° C. Again, the membrane electrode assembly with the present fluid diffusion layers had better performance at higher current densities. This result was unexpected however, given the through-plane resistivity and air flow characteristics of the comparative examples.

The through-plane resistivity of a fluid diffusion layer is an important characteristic relating to fuel cell performance. The through-plane resistivity is a measure of the electrical resistivity and reflects the performance of the fluid diffusion layer as a current collector and conductor.

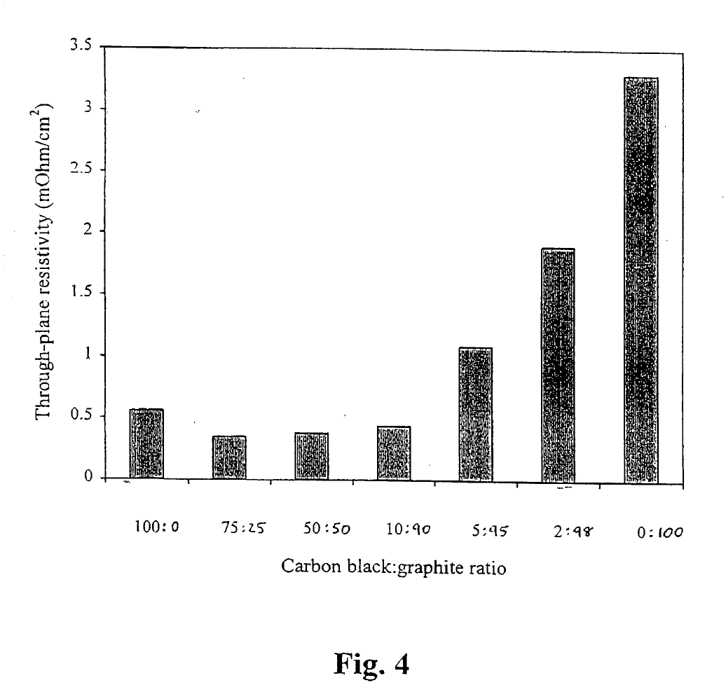

FIG. 4 shows the through-plane resistivity for fluid diffusion layers made with loading materials comprising varying ratios of acetylene carbon black to graphite particles. More specifically, fluid diffusion layers having weight ratios of acetylene carbon black to graphite of 100:0, 75:25, 50:50, 10:90, 5:95, 2:98, and 0:100 were prepared as described above. The through-plane resistivity was measured using a custom 4 point measuring jig at 200 (1.4 MPa) compression over an area of 5 cm² and a test current of 5 A. The results shown in FIG. 4 are the average of test results from 4 samples of each type.

As shown in FIG. 4, the effect of acetylene carbon black:graphite ratio on through-plane resistance is not linear. Superior through-plane resistance was obtained at weight ratios of acetylene carbon black to graphite from 75:25 to 10:90. At these ratios, through-plane resistivities less than 0.5 milliohms-cm² were obtained.

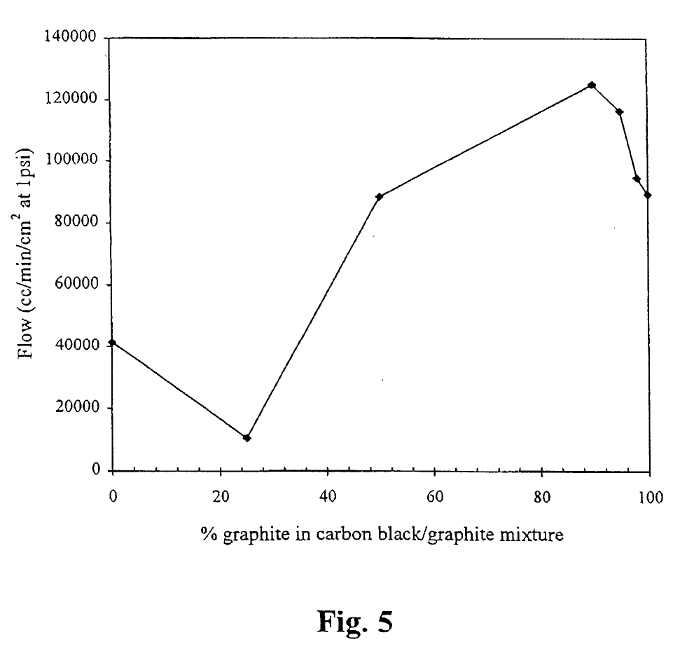

The air flow for a fluid diffusion layer is another important characteristic relating to fuel cell performance. FIG. 5 shows air flow in cc/minute/cm² at 1 psi (6.9 kPa) through the same fluid diffusion layers. The diamonds indicate actual measurements, while the sinusoidal curve shows the approximate relationship between air flow and acetylene carbon black/graphite weight ratios in the fluid diffusion layers. The results shown in FIG. 5 are the average of test results from 4 samples of each type.

FIG. 5 shows the effect on air flow due to the weight ratio of acetylene carbon black to graphite in the loading material. The relationship is not linear. At an acetylene carbon black:graphite ratio of 50:50, the air flow is about equal to that at 0:100 (in other words, 100% graphite). At ratios less than 50:50, the air flow is surprisingly greater than that at 0:100. Thus, at appropriate acetylene black:graphite ratios, both through-plane resistance and air flow characteristics can be obtained that equal or exceed those expected from use of pure acetylene black or pure graphite alone.

While particular elements, embodiments and applications of the present invention have been shown and described, it will be understood, of course, that the invention is not limited thereto since modifications may be made by those skilled in the art without departing from the scope of the present disclosure, particularly in light of the foregoing teachings.

What is claimed is:

1. A method of making a fluid diffusion layer for a fuel cell, the method comprising:
providing a substrate;
applying a loading composition to the substrate, the loading composition comprising a loading material and a carrier, the loading material comprising carbon black and graphite particles in a weight ratio of less than about 50:50; and
drying the substrate and the loading composition applied thereto.

2. A fluid diffusion layer comprising a substrate and a loading material, the loading material comprising carbon black and graphite particles in a weight ratio of less than about 50:50.

3. A fluid diffusion layer comprising a substrate and a loading material, the loading material comprising carbon black and graphite particles, the fluid diffusion layer having a through-plane resistance of about 0.5 millivolt or less and an air flow at 1 psi (6.9 kPa) of 80,000 cc/min or more.

4. A loading composition adapted to be applied to a substrate for the preparation of a fluid diffusion layer of the type used in solid polymer electrolyte fuel cells, the loading composition comprising a loading material and a carrier, wherein the loading material comprises carbon black and graphite particles in a weight ratio of less than about 50:50.

5. A method of preparing a fuel cell electrode, the method comprising:
providing a substrate;
applying a loading composition to the substrate, the loading composition comprising a loading material and a carrier, the loading material comprising carbon black and graphite particles in a weight ratio of less than about 50:50;
drying the substrate and the loading composition applied thereto, whereby a fluid diffusion layer is formed as a result of the applying and drying steps;
applying an aqueous catalyst composition comprising a fuel cell catalyst to the fluid diffusion layer; and
drying the fluid diffusion layer and the aqueous catalyst composition applied thereto, whereby an electrode is formed.

6. A fuel cell electrode comprising a fluid diffusion layer and a catalyst layer, and the fluid diffusion layer comprising a substrate and a loading material, the loading material comprising carbon black and graphite particles in a weight ratio of less than about 50:50.
